(19) United States
(12) Patent Application Publication
(10) Pub. No.: US 2007/0199779 A1
(43) Pub. Date: Aug. 30, 2007

(54) End-tapered brake shoe

(76) Inventors: Michael P. Tatera, St. Charles, IL (US); Glenn A. Guelde, Malta, IL (US); Zaheer M. Ahmed, Montgomery, IL (US); Daniel T. Gosselin, Naperville, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/362,669

(22) Filed: Feb. 27, 2006

(51) Int. Cl. F16D 69/00

(52) U.S. Cl. 188/257

(57) ABSTRACT

A railroad brake shoe has a pad has a central axis with an arcuate front face which terminates at upper and lower edges. Normal forces at an edge define a line of action. The pad includes support material on the side of the line of action opposite the central axis. The support material resists edge chipping and the formation of edge cracks.

### BACKGROUND OF THE INVENTION

Brake shoes manufactured for the railroad industry tend to be of different shapes and sizes, with typical lengths ranging from 12 inches to 18 inches. The brake heads that the brake shoes are installed into are typically 12 inches in length. It is a common practice to make the ends of the brake shoes flat or horizontal. Field surveys have revealed that there is a tendency of the friction material at the ends of these prior art brake shoes to chip and break off during use, thereby drastically reducing the useful life of the brake shoe. The tapered end brake shoe of the present invention is designed to address these issues.

FIG. 1 shows a drawing of a typical prior art 12-inch composition brake shoe 10 installed on a 12-inch brake head 12. During braking, a braking force, F_{A}, is applied by the brake shoe 10 onto the tread 14 of the wheel. Friction between the brake pads and the wheel tread 14 creates a resultant retarding force, F_{R}, to reduce the rotational speed of the wheel and cause it to stop.

Looking at forces in action on the ends of the brake pads, there is an applied braking force, F_{A}, acting on the pads, and there are forces created by friction between the brake pad and the rotating wheel. See FIG. 2. These forces acting on the ends include internal tensile forces, F_{T}, on one end of the brake shoe and internal compressive forces, F_{C}, on the other end depending on the direction of rotation of the wheel. In FIG. 2 the wheel is rotating in the direction shown by arrow A.

In FIG. 2, the internal tensile forces, F_{T}, on the top end of the brake shoe induces stresses on the brake pad and cause moment, M₁, in the friction material. The end of the brake shoe indicated has a resultant force, F_{N}, acting on it normal to the surface of the wheel, along what will be termed herein a line of action. This end area of the shoe tends to be the weakest as there are no equal and opposite forces acting on them to balance the force F_{N}. This imbalance of forces causes the end to slightly flex, and surface cracks may form. The tensile force, F_{T}, induces a moment M₁, which may pull the material apart causing end chipping. This is only evident on the end of the brake shoe where tensile forces are in play. This phenomenon is more evident when the brake heads and rigging are worn and sagging forward as indicated in FIG. 3, which is the commonly observed condition in the field. The end of the brake shoe pad catches the rotating wheel and has a greater tendency to break off during use. This is because the force now is concentrated on one point or small area and not by the entire face of the shoe.

The above phenomenon is a dynamic failure mechanism, as the main cause of end chipping is the induced stresses caused by the moment in the friction material created by the internal tensile forces F_{T} acting on the brake shoe ends when the wheel is rotating.

End chipping is more frequently observed in applications where the brake shoe length is longer than the brake head, such as 14-inch and larger flat end brake shoes on a 12-inch brake head. This is typically the case in locomotive applications. In this application, not only is there a dynamic failure mechanism (as explained above) acting on the ends of the brake shoes, but there is also a static mechanism, caused by the bending moment, M₂, on the ends of the shoe. FIG. 4 shows an example of a 14-inch brake shoe 16 installed on a 12-inch brake head 12. Due to the 1-inch overhang of the brake shoe ends, the applied braking force, F_{A}, and the normal force, F_{N}, create a bending moment M₂, which bends and flexes the ends of the brake shoe and minor cracks initiate on the surface of the brake pad. Both dynamic and static forces act on the ends of the brake shoes. The cracks on the surface propagate through the thickness of the pad under dynamic tensile shear forces, F_{T}, causing the pad ends to break off during use.

This mechanism is accelerated in the presence of improper rigging where brake head alignment is not perpendicular to the wheel surface. Not only are there localized dynamic forces at the end creating a higher moment M₁, but there is also a higher static bending moment, M₂, causing the ends to bend and crack. Field observations have revealed that in some cases the bending moment, M₂, is large enough to even bend the steel backs when the brakes are applied See FIG. 5. The dynamic tensile shear forces, F_{T}, cause the cracks to propagate into the material from the face of the brake pad causing end chipping.

The static bending moment, M₂, is also prominent when brake shoes are used on wheels that have a larger diameter than the brake shoe face. This is because the ends of the brake shoe are in contact with the wheel creating force concentration points at the ends, and hence will have a greater tendency to bend when the brake is applied. This bending moment, M₂, and the cracks on the brake shoe surface caused by it can be evident on all brake shoes greater than 12 inches.

### SUMMARY OF THE INVENTION

The end-tapered brake shoe of the present invention is designed to address end-chipping issue observed in the field. The shoe has an arcuate pad that defines a center line. The arc of the pad terminates at upper and lower edges. The edges join tapered upper and lower end faces. The end faces extend to boundaries where they join a rear face of the pad. Normal forces acting on the front face of the pad define a line of action at the upper and lower edges of the front face. The end faces are tapered such that there is support material on the pad outside of the line of action, i.e., on the side of the line of action opposite the central axis of the pad. This support material resists end chipping. Stated alternately, the edges of the front face are closer to the central axis than are the boundaries at the rear face.

### BRIEF DESCRIPTION OF THE DRAWINGS

FIG. 1 is a schematic side elevation view of a prior art 12-inch brake shoe installed on a brake head adjacent a car wheel.

FIG. 2 is a diagram of forces acting on the ends of a prior art 12-inch flat end brake shoe mounted on a brake head.

FIG. 3 is a diagram of forces acting on the ends of a prior art 12-inch flat end brake shoe mounted on a sagging brake head.

FIG. 4 is a diagram of forces acting on the ends of a prior art 14-inch flat end brake shoe mounted on a brake head.

FIG. 5 is a diagram of forces acting on the ends of a prior art 14-inch flat end brake shoe mounted on a brake head with improper rigging.

FIG. 6 is a schematic side elevation view of a 12-inch brake shoe according to the present installed on a brake head adjacent a car wheel.

FIG. 7 is a diagram of forces acting on the ends of a 12-inch tapered end brake shoe according to the present invention mounted on a brake head.

FIG. 8 is a diagram of forces acting on the ends of a 12-inch tapered end brake shoe according to the present invention mounted on a sagging brake head.

FIG. 9 is a diagram of forces acting on the ends of a 14-inch tapered end brake shoe according to the present invention mounted on a brake head.

FIG. 10 is a diagram of forces acting on the ends of a 14-inch tapered end brake shoe according to the present invention mounted on a brake head with sagging rigging.

FIG. 11 is a side elevation view of a 12-inch brake shoe of the present invention.

FIG. 12 is a front elevation view of a 12-inch brake shoe of the present invention.

FIG. 13 is a section taken along line 13-13 of FIG. 11.

FIG. 14 is a side elevation view of a 12-inch brake shoe of the present invention.

FIG. 15 is a front elevation view of a 12-inch brake shoe of the present invention.

FIG. 16 is a section taken along line 16-16 of FIG. 14.

FIG. 17 is a section taken along line 17-17 of FIG. 14.

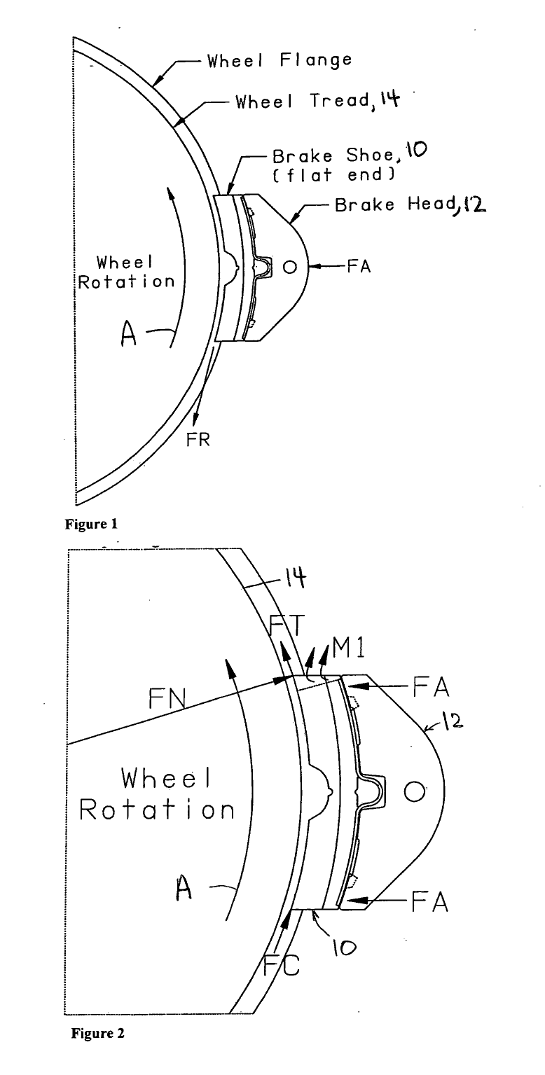

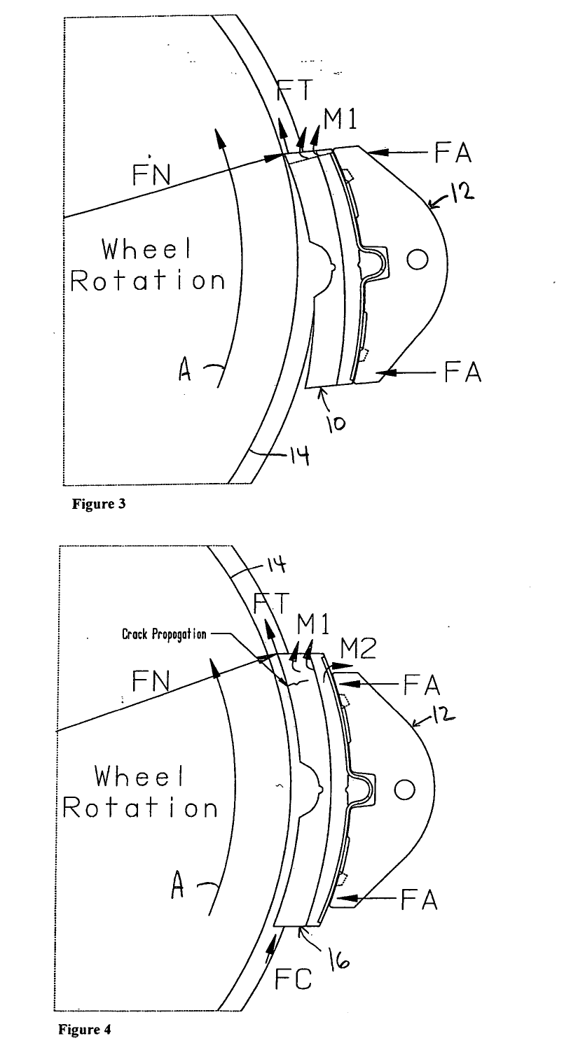

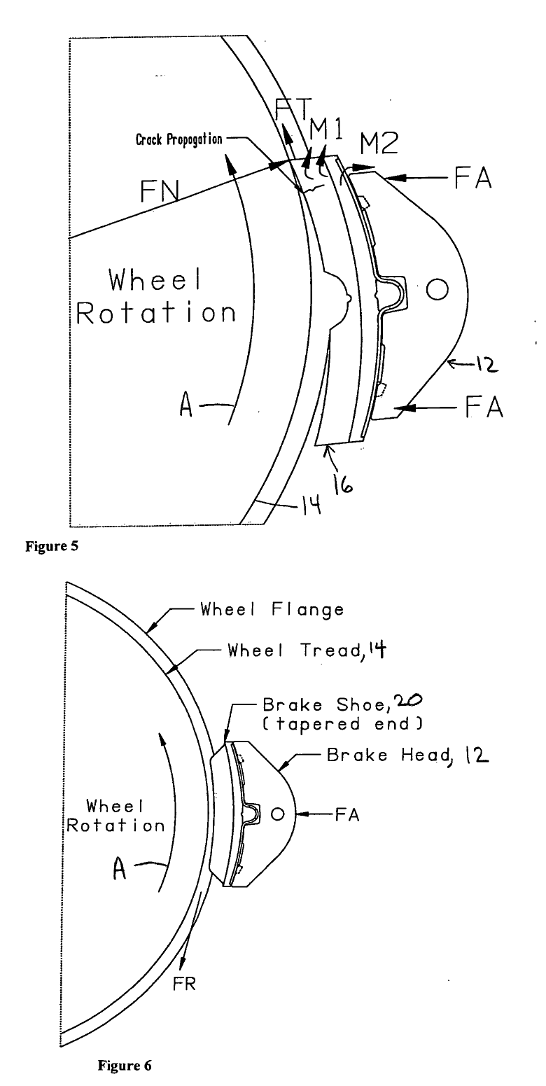

### DETAILED DESCRIPTION OF THE INVENTION

FIG. 6 shows the general design features of an end-tapered brake shoe of the present invention installed on a 12-inch brake head. During braking, a brake force, F_{A}, is applied by the brake shoe onto the tread of the wheel, and friction between the brake pads and the wheel tread creates a resultant retarding force, F_{R}, to reduce the rotational speed of the wheel and cause it to stop.

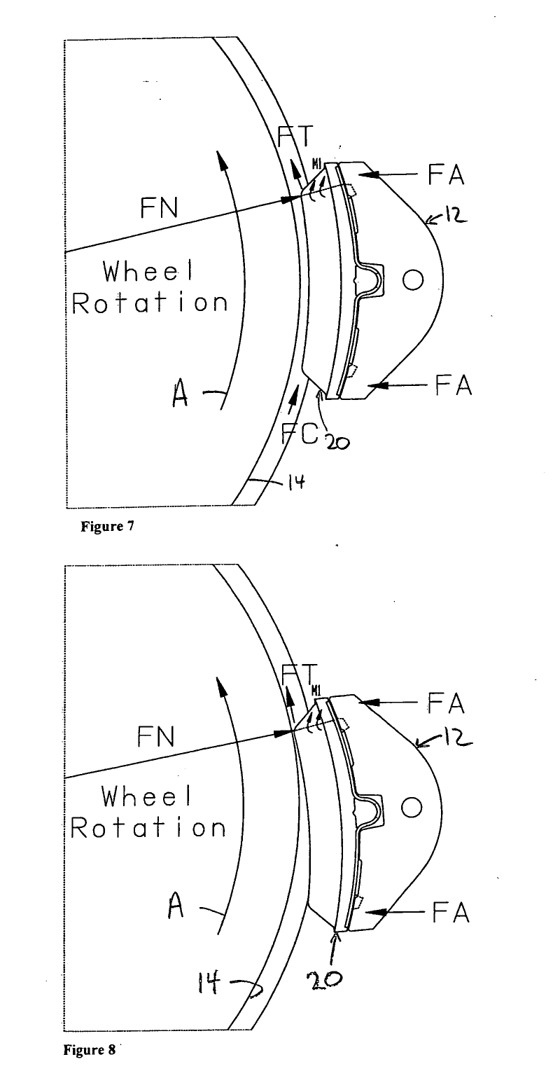

Looking at the forces acting on the ends of the end-tapered brake shoe, there is a applied braking force, F_{A}, acting on the pads, and there are also internal tensile forces, F_{T}, and internal compressive forces, F_{C}, acting on the ends created by friction between the brake pad and the rotating wheel. See FIG. 7. The tensile forces, F_{T}, cause a moment, M₁, on the ends. As compared to the flat end design, the plane around which this moment acts is supported by material on the outside, thereby preventing any end chipping. The normal forces, F_{N}, acting on the brake pad by the wheel are also balanced throughout the face of the brake shoe, so there are no areas of the brake pad that are susceptible to bending and crack formation.

Even in sagging brake rigging conditions, the end-tapered design is more robust and the ends conform well to the wheel surface. See FIG. 8. The normal forces, F_{N}, on the shoe act in a plane that is well supported by the steel back. The moments, M₁, also act about this plane due to the tensile forces F_{T}, but are well supported by the material on the ends.

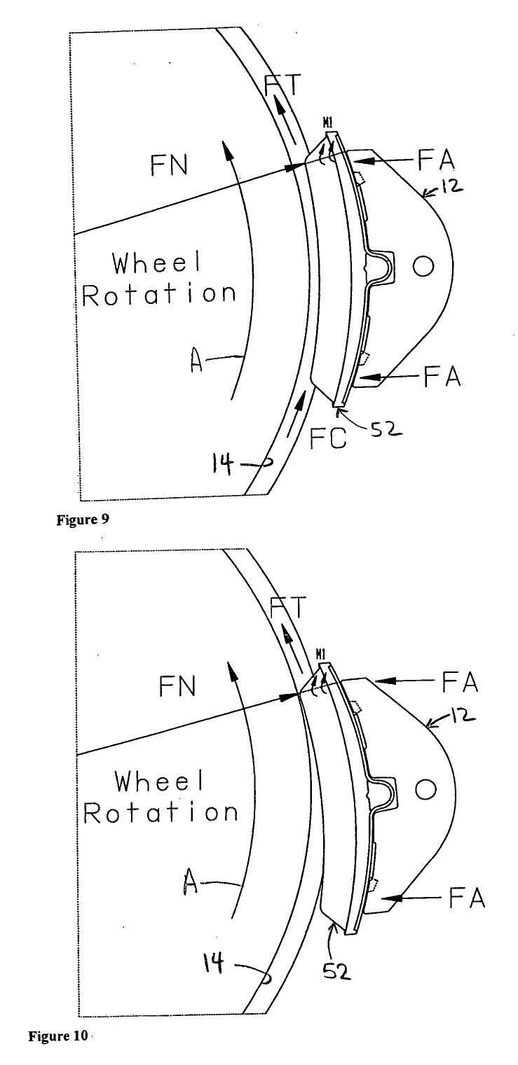

The end-tapered design will also function well in the case where the brake shoe is larger than the brake head. For example, in the case of a 14-inch end-tapered brake shoe installed on a 12-inch brake head, as seen in FIG. 9, used mainly in locomotive applications, the normal forces, F_{N}, are balanced throughout the face of the brake shoe. In other words there is no static force F_{N} at the tip of the shoe as seen earlier in FIG. 4 flat end shoes that results in the bending moment M₂. Since there is no bending moment, M₂, being created, there is no bending or flexing of the brake pad or steel back and no crack formation on the shoe face. The dynamic tensile shear force, F_{T}, acts on the surface such that the moments, M₁, being created fall within the brake pad material. The supporting material on the ends of the shoe prevents any edge chipping from occurring.

For brake shoes that are larger than the brake head as well as used brake shoes, the design conforms well with worn and sagging brake rigging. As seen in FIG. 10, all areas and ends of the brake pad are well supported. There is no chance for the ends to bend, nor for cracks on the surface to be created.

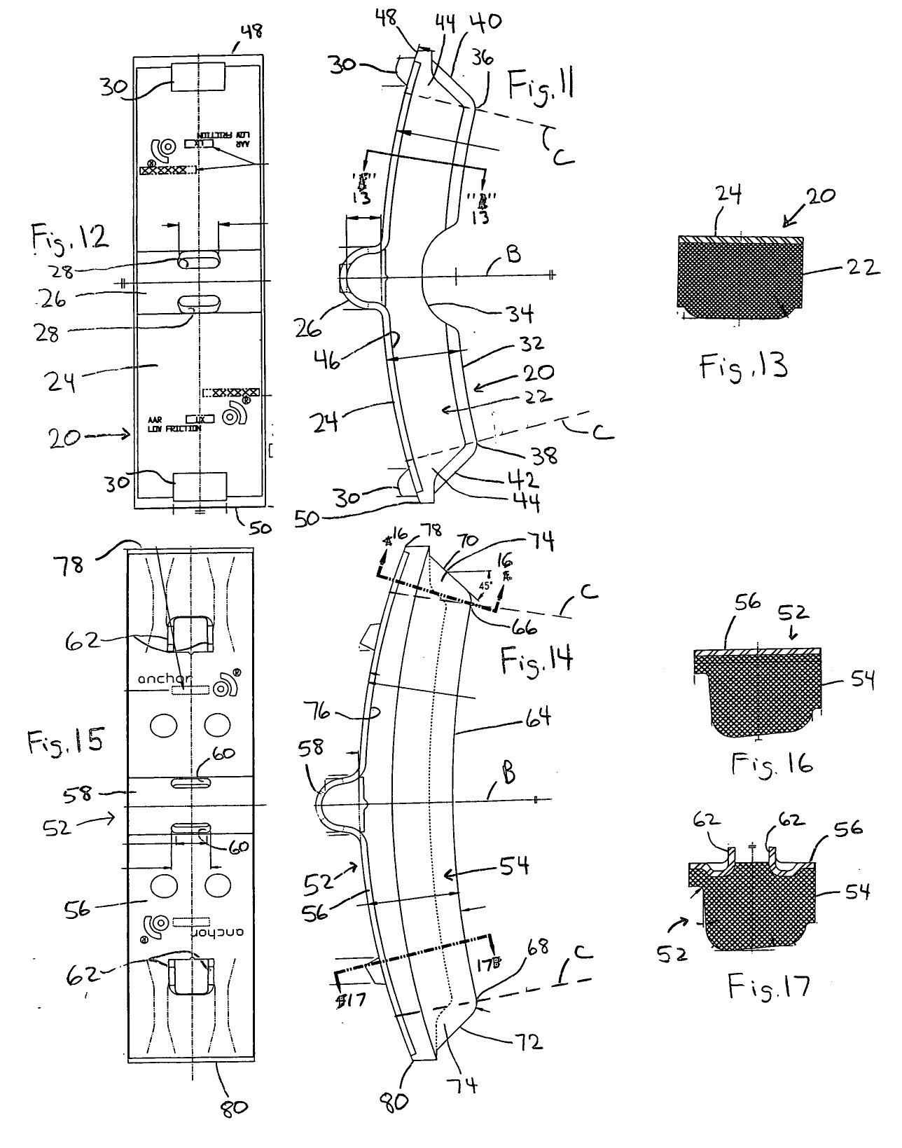

FIGS. 11-13 illustrate a 12-inch low friction composition brake shoe 20 according to the present invention. It has an arcuate core or pad 22 fixed to a steel backing plate 24. The backing plate has the usual key lug 26 with slots 28 formed therein for receiving a key to lock the shoe onto a brake head. Additional lugs 30 are formed on each end of the backing plate 24. The front surface or face 32 of the pad 22 may have an arcuate depression as at 34. The front face 32 defines a continuous arc having a central axis indicated by line B. The radius of the front face preferably matches that of the wheel tread. Upper and lower edges 36, 38 are defined at the point where the front face begins to deviate from its primary arcuate shape. The edges, together with the front face immediately adjacent the edges define a line of action, indicated in FIG. 11 at line C. The line of action is defined as a line extending through one of the edges 36, 38 and normal to the front face 32 at the edge. It can be seen that this is the line along which the normal forces, F_{N}, act on the shoe (see FIGS. 7-10).

At radiused corners the edges 36, 38 join upper and lower end faces 40, 42. The end faces are tapered with respect to the central axis B such that they extend outside of the line of action C. With the end faces so arranged, the pad has support material 44 on the side of the line of action opposite the central axis B of the pad. As explained above, it is this support material that prevents any edge chipping or cracking.

The end faces 40, 42 join a rear face 46 of the pad 22 at upper and lower boundaries 48, 50. It can be seen that the end faces are angled such that the upper and lower edges 36, 38 of the front face 32 are located closer to the central axis B than the upper and lower boundaries 48, 50 of the rear face 46. In a preferred embodiment the major portions of the end faces form an angle of about 45° with the central axis B. This geometry assures that the pad will include support material 44 outside of the line of action C.

FIGS. 14-17 illustrate another embodiment of the present invention. This is a 14-inch high friction composition brake shoe 52. It is similar to the shoe 20 in that it has an arcuate core or pad 54 fixed to a steel backing plate 56. A key lug 58 has slots 60 for receiving a key to lock the shoe onto a brake head. Lugs 62 are formed intermediate the ends of the backing plate 56. The front face 64 of the pad 54 defines a continuous arc having a central axis indicated by line B. Upper and lower edges 66, 68 are defined at the point where the front face 64 begins to deviate from its primary arcuate shape. As before, the edges 66, 68 and the portion of the front face 64 immediately adjacent the edges define a line of action, indicated in FIG. 14 at line C. The line of action is defined as a line extending through one of the edges 66, 68 and normal to the front face 64 at the edge. Again, FIGS. 7-10 show that this is the line along which the normal forces, F_{N}, act on the shoe.

The pad 54 has upper and lower end faces 70, 72. The front face's upper and lower edges 66, 68 join the upper and lower end faces 70, 72 at radiused corners. As in the previous embodiment, the end faces are tapered with respect to the central axis B such that they extend outside of the line of action C. This arrangement assures formation of support material 74 on the side of the line of action opposite the central axis B of the pad. The support material 74 prevents any edge chipping or cracking.

The upper and lower end faces 70, 72 join a rear face 76 of the pad 54 at upper and lower boundaries 78, 80. The end faces are angled such that the upper and lower edges 66, 68 of the front face 64 are located closer to the central axis B than the upper and lower boundaries 78, 80 of the rear face 76. Preferably, the major portions of the end faces form an angle of about 45° with the central axis B. This geometry assures that the pad will include support material 74 outside of the line of action C.

While the preferred form of the invention has been shown and described herein, it should be realized that there may be many modifications, substitutions and alterations thereto. For example, while the end faces of the pads are shown as largely a straight line from the front face of the pad to the rear face, the end face could have other configurations. Any sort of notch or undercut at the intersection of the front face and end face may be used to move the edges of the front face toward the central axis B. Also, while it is most advantageous to provide the support material at both the upper and lower ends of the shoe, it might be possible to arrange just one of the ends with support material and make the other end conventional.

We claim:

1. A brake shoe, comprising a pad having an arcuate front face terminating at upper and lower edges, the front face defining a central axis and a line of action which extends through an edge and normal to the front face, the pad including support material located on the side of the line of action opposite the central axis.

2. The brake shoe of claim 1 wherein the pad includes upper and lower end faces, at least one of the end faces extending at an angle of about 45° to the central axis.

3. The brake shoe of claim 1 wherein there is support material located at both the upper and lower edges of the pad.

4. A brake shoe, comprising a pad having an arcuate rear face terminating at upper and lower rear boundaries, an arcuate front face terminating at upper and lower edges, the front face defining a central axis, the edges of the front and rear faces being joined by end faces, at least one of the edges of the front face being located closer to the central axis than is the boundary of the rear face connected to said at least one edge.

5. The brake shoe of claim 4 wherein the end faces extend at an angle of about 45° to the central axis.

6. The brake shoe of claim 4 wherein both the upper and lower edges are located closer to the central axis than are the boundaries of the rear face.

7. A method of preventing end chipping in railroad brake shoes, comprising the steps of forming a pad having an arcuate front face terminating at upper and lower edges, the front face defining a central axis and a line of action which extends through an edge and normal to the front face, and providing support material at the ends of the pad on the side of the line of action opposite the central axis.
